(19) United States
(12) Patent Application Publication
(10) Pub. No.: US 2012/0279539 A1
(43) Pub. Date: Nov. 8, 2012

(54) ELECTRONIC CANE FOR THE VISUALLY IMPAIRED FOR RECOGNIZING RFID TAGS

(76) Inventor: Sung Jae Kim, Daegu (KR)

(21) Appl. No.: 13/520,335

(22) PCT Filed: Dec. 22, 2010
(86) PCT No.: PCT/KR2010/009215

§ 371 Date: Jul. 2, 2012

(30) Foreign Application Priority Data
Dec. 30, 2009 (KR) 10-2009-0133528

(51) Int. Cl. A61H 3/06

(52) U.S. Cl. 135/66

(57) ABSTRACT

The present invention relates to an electronic walking cane for the visually impaired which is adapted with an RFID reader to wirelessly detect RFID tags which are positioned as guides along footpaths with Braille blocks having embedded RFID tags. The present electronic walking cane comprises: a handle which is in the shape of a hollow tube within which a circuit board is installed; a plurality of connectors each having a tapering, hollow tubular structure which are sequentially mounted into each other such that the lower end of one connector is inserted into the upper end of the next connector; a coiled cable, consisting of a plurality of coated wires, with one end connected to said handle and the other end connected to the tip of the lowest of said plurality of connectors; an elastic member for preventing the twisting of said coiled cable, is inserted into the medial section of said coiled cable, with one end connected to said handle and the other end connected to the tip of the lowest of said plurality of connectors; a first and a second fastener which respectively fasten said handle to each of said plurality of connectors, and said coiled cable to said elastic member; and an insulating material having a cylindrical structure installed onto the inner surface of said plurality of connectors, which reduces noises which occur when said elastic member, said coiled cable and said plurality of connectors rub against each other with movement of said walking cane.

### TECHNICAL FIELD

The present invention relates to an electronic walking cane for the visually impaired for recognizing RFID tags, more particularly, an electronic walking cane of telescopic type for the visually impaired for recognizing RFID tags which guides the visually impaired along a footpath by wirelessly detecting RFID tags embedded in Braille blocks with RFID reader provided in the walking cane when the visually impaired walks along the Braille blocks.

### BACKGROUND ART

In general, the visually impaired walks while perceiving location and danger by detecting protrusions of guide blocks on the ground with the walking cane. However, with such a way, the visually impaired may not know correct current location and advance direction to walk along, and when going to a certain place for the first time, has no choice but to obtain location information about the place from surrounding people. Therefore, for the place to go to for the first time, another guide person is needed.

Currently, guide blocks are utilized by adding it among sidewalk blocks in order to guide the visually impaired to places requiring caution such as walk crossing, entrance door for getting on and off the subway, steps etc. or a specific location.

However, such conventional guide blocks are made of material different from material for common blocks such as rubber, stainless steel, plastic, magnetic material etc., and the visually impaired detects the protrusions by his/her walking cane or foot. Furthermore, the visually impaired detects the guide blocks through sound or feeling by beating the blocks with the walking cane carried along or dragging the walking cane.

The visually impaired detects the Braille blocks by feeling only with the shape of protrusions on the Braille blocks struck by the walking cane shaken about, and the type of message transmitted to the visually impaired by the shape in this way is mainly classified to three types and narrowly limited thereto, and actually, problems of slow detection speed, inconvenience and incorrectness are present in safely guiding the visually impaired to a desired place only with these messages when the visually impaired walks.

For provision of information for the visually impaired, only acoustic information transmission using voice or sound etc. and tactile information transmission using Braille plate etc. are possible. The acoustic information transmission allows fast and correct transmission compared to the tactile information transmission. Many methods have been studied which enable the visually impaired to receive location information that the visually impaired can obtain by himself or herself.

Meanwhile, as prior art relating to a walk guiding apparatus for the visually impaired, Korean Registered Utility Model No. 20-0203332 proposes a guiding apparatus wherein ultrasonic wave generating device and vibration device are installed in the walking cane to detect surrounding obstacles with the ultrasonic wave and upon detection of the obstacles the presence of the obstacles are notified by driving a vibrator. However, such a guiding apparatus using the ultrasonic wave can detect and notify nearby obstacles, but cannot distinguish moving persons and fixed obstacles in place crowded with people, hence a problem is present that the guiding apparatus rather becomes an obstruction and may cause confusion.

In order to solve such a problem, Korean Published Patent Application No. 10-0647069 discloses a technique wherein RFID tags are mounted in blocks and the RFID tags are read in a contactless manner for voice guide and infrared reflection lane is formed on guide lane, thus a function is added of recognizing the reflection guide lane regardless of whether the walking cane is contacted or not and forward, rearward, leftward and rightward direction of the walking cane are sensed to thereby guide the advance direction with voice.

According to a conventional walk guiding system for the visually impaired disclosed in Korean Registered Patent No. 10-0647069, RFID tags are mounted in the blocks installed on the footpath, RFID reader is mounted in lower section of the walking cane for the visually impaired, and thereafter wireless signal is emitted through antenna of the RFID reader and information is read from nearby RFID tags, so forward, rearward, leftward and rightward advance direction is guided with voice.

Common walking cane of telescopic type other than the electronic walking cane for the visually impaired is disclosed in Korean Registered Utility Model Publication No. 1998-6674. According to an automatically released walking cane of button type for the visually impaired disclosed in Korean Registered Utility Model Publication No. 1998-6674, a spring is attached to each joint of the existing walking cane, and if the button is pushed, a catching hook supporting the button is lifted upward and at the same time the contracted springs are released all together, whereby the walking cane is automatically extended at a time.

Furthermore, for collapsing the walking cane, if it is abutted at its lower section on the ground and then merely pressed by applying force to the walking cane, the released springs are contracted all together and at the same time the catching hook is caught on a securing device of a cap part, whereby the walking cane can be easily collapsed. This securing device is constructed such that the walking cane is prevented from being wrongly released as long as the user does not voluntarily push the release button of the walking cane in its collapsed state.

By the way, such a common walking cane of telescopic type is not equipped with electric wire cable, so there is no problem in using it, but in recent, in case of mounting the RFID tags in the Braille blocks and mounting the RFID reader in the walking cane, since the antenna is mounted at lower end portion of the walking cane, the electric wire cable has to be connected up to a circuit board provided with the RFID reader.

There are problems that it is difficult to connect the electric wire cable from the lower end portion of the walking cane to the circuit board provided with the RFID reader at the upper end portion, and even though straight electric wire cable is connected, when collapsing or extending the walking cane, the electric wire cable is twisted due to rotation to thereby be broken or soldered portion is detached, as a result, the electronic walking cane cannot be used.

Due to such problems, the conventional electronic walking cane is not used in a telescopic manner, and instead a long walking cane of rod type formed in one piece is used, which has a problem that it is inconvenient for the user to store such a long walking cane when getting on the subway or bus.

### DISCLOSURE OF THE INVENTION

An object of the present invention is to an electronic walking cane for the visually impaired for recognizing RFID tags wherein when the electronic walking cane of walk guiding system utilizing the RFID tags is formed in a telescopic manner, the twisting of the electric wire cable is prevented and thus breaking of the electric wire cable or electric wire soldering portion of the electric wire cable can be prevented.

Another object of the present invention is to an electronic walking cane for the visually impaired for recognizing RFID tags which can be collapsed to be stored in user's bag when getting on the subway or bus, thus is convenient to carry along.

An electronic walking cane for the visually impaired for recognizing RFID tags for achieving the above object is characterized in that it comprises a pillar tube which is used as a handle and within which a circuit board is installed; a plurality of connection tubes which are sequentially secured to another connection tube such that a first connection tube is inserted from a upper end portion of the pillar tube to a lower end portion thereof through a insertion through hole formed in the pillar tube to be secured within the lower end portion and other connection tubes are successively inserted from a upper end portion of a different connection tube to a lower end portion thereof to be secured within the lower end portion; a coiled cable of which both end portions are fastened to the pillar tube and the lowest connection tube of the plurality of connection tubes, respectively, and within which a plurality of coated electric wires are longitudinal arranged; an elastic member which is inserted inside the coiled cable and fastened to the pillar tube and the lowest one of the plurality of connection tubes, respectively to prevent the twisting of the coiled tube; a first fastener which is formed within the upper section of the pillar tube to fasten one side of each of the elastic member and coiled cable; a second fastener which is formed within the lower section of the lowest inserted connection tube of the plurality of connection tubes to fasten the other side of each of the elastic member and coiled cable; and a plurality of cylindrical buffering element which are installed within an end portion of the upper section of the plurality of connection tubes to reduce noise generated when the elastic member and coiled cable strike the plurality of connection tubes due to shaking of the walking cane.

The electronic walking cane for the visually impaired of the present invention is characterized in that the plurality of connection tubes are formed in four-stage.

The electronic walking cane for the visually impaired of the present invention is characterized in that the elastic member is a coil spring or rubber string.

The electronic walking cane for the visually impaired of the present invention is characterized in that the pillar tube and the plurality of connection tubes are formed in such a manner that they are gradually narrower from upper end portion to lower end portion.

The present invention has an advantage that when the visually impaired extends or contracts the electronic walking cane of telescopic type, the twisting of the electric wire cable is prevented and thus breaking of the electric wire cable or electric wire soldering portion of the electric wire cable can be prevented.

The present invention has further advantage that the visually impaired can contract and then conveniently store the electronic walking cane of telescopic type when getting on the subway or bus.

### BRIEF DESCRIPTION OF THE DRAWINGS

FIG. 1 is a structural view illustrating an extended state of an electronic walking cane for the visually impaired according to an example of the present invention.

FIG. 2 is a structural view illustrating a contracted state of an electronic walking cane for the visually impaired according to an example of the present invention.

### MODES FOR CARRYING OUT THE INVENTION

Hereinafter, a preferred example of the present invention will be described in more detail with reference to the illustrated attached drawings. However, it should be understood that the present invention may be embodied in a plurality of different forms and is not limited to a described example. It should be noted that the example of the present invention described below is merely intended to explain the concept of the present invention to persons skilled in the art and detailed description will be omitted of functions and constructions known in the art which may unnecessarily obscure the gist of the present invention.

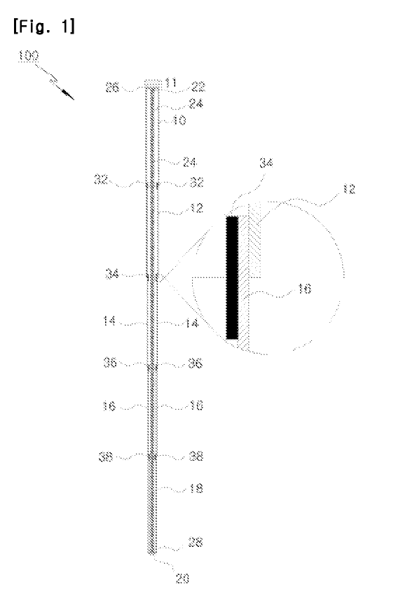

FIG. 1 is a structural view illustrating an extended state of an electronic walking cane for the visually impaired according to an example of the present invention.

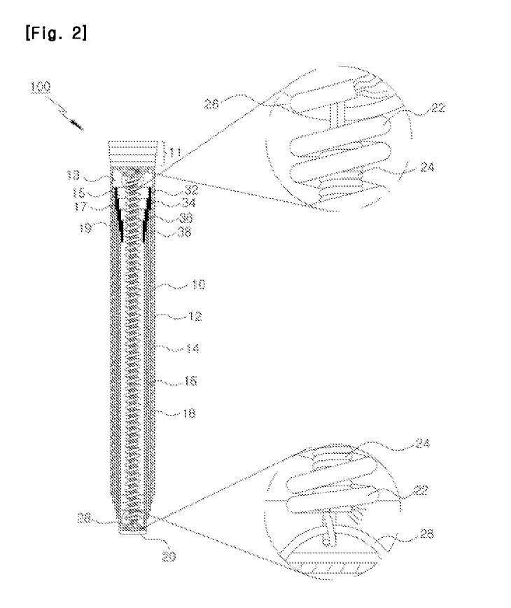

FIG. 2 is a structural view illustrating a contracted state of an electronic walking cane for the visually impaired according to an example of the present invention.

The electronic walking cane for the visually impaired of the present invention comprises:

A pillar tube (10) to which a circuit mounting part (11) is joined;

A first connection tube (12) which is inserted into upper section of the pillar tube (10) and secured within lower section thereof;

A second connection tube (14) which is inserted into upper section of the first connection tube (12) and secured within lower section thereof;

A third connection tube (16) which is inserted into upper section of the second connection tube (14) and secured within lower section thereof;

A fourth connection tube (18) which is inserted into upper section of the third connection tube (16) and secured within lower section thereof, and within a lower end portion of which an antenna (20) is installed;

A coiled cable (22) which is secured to an end portion of the pillar tube (10) and an end portion of the fourth tube (18), respectively and within which a plurality of coated wires are longitudinally arranged;

An elastic member (24) which is inserted inside the coiled cable (22) and fastened to the end portion of the pillar tube (10) and the end portion of the fourth tube (18), respectively to prevent the twisting of the coiled tube (22);

A first fastener (26) which is formed within the upper section of the pillar tube (10) to fasten one side of each of the coiled cable (22) and elastic member (24);

A second fastener (28) which is formed within the lower section of the fourth connection tube (18) to fasten the other side of each of the coiled cable (22) and elastic member (24);

A first cylindrical buffering element (32) which is installed within an end portion of the upper section of the first connection tube (12) to reduce noise generated when the coiled cable (22) and elastic member (24) strike the first connection tube (12) due to shaking of the walking cane;

A second cylindrical buffering element (34) which is installed within an end portion of the upper section of the second connection tube (14) to reduce noise generated when the coiled cable (22) and elastic member (24) strike the second connection tube (14) due to shaking of the walking cane;

A third cylindrical buffering element (36) which is installed within an end portion of the upper section of the third connection tube (16) to reduce noise generated when the coiled cable (22) and elastic member (24) strike the third connection tube (16) due to shaking of the walking cane; and

A fourth cylindrical buffering element (38) which is installed within an end portion of the upper part of the fourth connection tube (18) to reduce noise generated when the coiled cable (22) and elastic member (24) strike the fourth connection tube (18) due to shaking of the walking cane.

With reference to the above-mentioned FIGS. 1 and 2, a preferred electronic walking cane for the visually impaired of the present invention will be described in detail.

In the pillar tube (10), a circuit board (not illustrated) is installed in the circuit mounting part (11) and a first insertion through hole (13) is formed for inserting the first connection tube (12). In the first connection tube (12), a second insertion through hole (15) is formed for inserting the second connection tube (14). In the second connection tube (14), a third insertion through hole (17) is formed for inserting the third connection tube (16). In the third connection tube (16), a fourth insertion through hole (19) is formed for inserting the fourth connection tube (18).

Then, installed within the upper section of the pillar tube (10) is the first fastener (26) for fastening one side of each of the coiled cable (22) and elastic member (24).

Installed within the lower section of the fourth connection tube (18) is the second fastener (28) for fastening the other side of each of the coiled cable (22) and elastic member (24).

When the pillar tube (10) and the first to fourth connection tubes (12, 14, 16, 18) are inserted into another and then secured, the coiled cable (22) with four coated electric wires longitudinally arranged within the cable and the elastic member (24) inserted inside the coiled cable (22) to prevent the twisting of the coiled cable (22) are fastened at the first and second fasteners (26, 28) so as not to be separated.

Then, the first cylindrical buffering element (32) is installed within an end portion of the upper section of the first connection tube (12) and reduces noise generated when the coiled cable (22) and elastic member (24) strike the first connection tube (12) due to shaking of the walking cane.

The second cylindrical buffering element (34) is installed within an end portion of the upper section of the second connection tube (14) and reduces noise generated when the coiled cable (22) and elastic member (24) strike the second connection tube (14) due to shaking of the walking cane.

The third cylindrical buffering element (36) which is installed within an end portion of the upper section of the third connection tube (16) and reduces noise generated when the coiled cable (22) and elastic member (24) strike the third connection tube (16) due to shaking of the walking cane.

The fourth cylindrical buffering element (38) which is installed within an end portion of the upper section of the fourth connection tube (18) and reduces noise generated when the coiled cable (22) and elastic member (24) strike the fourth connection tube (18) due to shaking of the walking cane.

For material for the first to fourth buffering elements (32, 34, 36, 38), sponge or cork material or styrofoam etc. may be used for example, and all of another buffering material may be also used.

For the electronic walking cane (100) for the visually impaired formed as described above, the first connection tube (12) is inserted from above the first insertion through hole (13) formed in the pillar tube (10) to a lower end portion thereof, the second connection tube (14) is inserted from above the second insertion through hole (15) formed in the first connection tube (12) to a lower end portion thereof, the third connection tube (16) is inserted from above the third insertion through hole (17) formed in the second connection tube (14) to a lower end portion thereof, and the fourth connection tube (18) is inserted from above the fourth insertion through hole (19) formed in the third connection tube (16) to a lower end portion thereof. The pillar tube (10) and the first to fourth connection tubes (12, 14, 16, 18) are formed in such a manner that they are gradually narrower from upper end portion to lower end portion, whereby upper end portion of the first connection tube (12) is caught and secured by lower end portion of the pillar tube (10), upper end portion of the second connection tube (14) is caught and secured by lower end portion of the first connection tube (12), upper end portion of the third connection tube (16) is caught and secured by lower end portion of the second connection tube (14), and upper end portion of the fourth connection tube (18) is caught and secured by lower end portion of the third connection tube (16). If the pillar tube (10) and the first to fourth connection tubes (12, 14, 16, 18) are pulled with all user's force, the upper section and lower section are tightly caught and secured, and hence tightening force of the upper and lower sections is larger than pulling force of the elastic member (24), so the electronic walking cane (100) can be kept in extended state.

While the electronic walking cane (100) for the visually impaired thus assembled is used in the extended state, even if a specific one of the first to fourth connection tubes (12, 14, 16, 18) is rotated, the elastic member (24) and coiled cable (22) are returned to their original positions due to the elasticity of the elastic member (24) if the rotated one of the first to fourth connection tubes (12, 14, 16, 18) is released from the rotated state, whereby the coiled cable (22) is not twisted and at this time breaking of the four coated electric wires arranged within the coiled cable (22) is prevented or the coated electric wires prevent detachment of solder of coated wire formed on the antenna (20) and the circuit board arranged in the circuit mounting part (11). Coil spring or rubber string may be used for the elastic member (24), and in one example of the present invention, the use of coil spring is illustrated by example.

Two electric wires of the four coated electric wires arranged within the coiled cable (22) are “+” and “−” power supply wires and other two electric wires are used as signal transmission wire (Tx) and signal reception wire (Rx), and since the signal transmission wire (Tx) and signal reception wire (Rx) each require two electric wires, the “−” electric wire of the power supply wires is used in common in transmitting and receiving the signal.

In one example of the present invention, the electronic walking cane (100) is constructed in 5-stage by comprising the pillar tube (10) and the first to fourth connection tubes (12, 14, 16, 18), but may be constructed in conformance with the size of the walking cane to be carried along in the range from 2-stage to 8-stage.

In case that the electronic walking cane (100) for the visually impaired is used as described above and then is not used while its user is riding on the subway or bus or passenger car for example, if the first to fourth connection tubes (12, 14, 16, 18) are pushed in by applying force thereto, the electronic walking cane (100) is contracted, thus carried along while being put in user's bag etc. In order to contract the electronic walking cane (100) for the visually impaired, the first connection tube (12) is pushed into the pillar tube (10), the second connection tube (14) is pushed into the first connection tube (12), the third connection tube (16) is pushed into the second connection tube (14), and the fourth connection tube (18) is pushed into the third connection tube (16), and as a result, the electronic walking cane becomes short as illustrated in FIG. 2.

Although the present invention has been described in detail with reference to the written specific example, it is obvious to persons skilled in the art that various alterations and modifications can be made within the scope of technical concept of the present invention, and these alteration and modifications naturally fall within the appended claims.

1. An electronic walking cane for the visually impaired for recognizing RFID tags, comprising:
a pillar tube which is used as a handle and within which a circuit board is installed;
a plurality of connection tubes which are sequentially inserted such that a first connection tube is inserted from above a first insertion through hole formed in the pillar tube to a lower end portion thereof, a second connection tube is inserted from above a second insertion through hole formed in the first connection tube to a lower end portion thereof, a third connection tube is inserted from above a third insertion through hole formed in the second connection tube to a lower end portion thereof, and a fourth connection tube is inserted from above a fourth insertion through hole formed in the third connection tube to a lower end portion thereof;
a coiled cable of which both end portions are fastened to a first fastener formed within upper section of the pillar tube and a second fastener of the fourth connection tube which is a lowest one of the plurality of connection tubes, respectively, and within which a plurality of coated electric wires are longitudinal arranged;
an elastic member which is inserted inside the coiled cable and fastened to the pillar tube and the second fastener of the fourth tube of the plurality of connection tubes, respectively to prevent the twisting of the coiled tube and pull the pillar tube and the fourth connection tube such that the plurality of connection tubes are not separated from each other; and
a plurality of cylindrical buffering element which are installed within an end portion of the upper section of the plurality of connection tubes to reduce noise generated when the elastic member and coiled cable strike the plurality of connection tubes due to shaking of the walking cane.

2. The electronic walking cane for the visually impaired for recognizing RFID tags according to claim 1, wherein the plurality of connection tubes are formed in four-stage.

3. The electronic walking cane for the visually impaired for recognizing RFID tags according to claim 2, wherein the elastic member is a coil spring or rubber string.

4. The electronic walking cane for the visually impaired for recognizing RFID tags according to claim 1, wherein the pillar tube and the plurality of connection tubes are formed in such a manner that they are gradually narrower from upper end portion to lower end portion.

5. The electronic walking cane for the visually impaired for recognizing RFID tags according to claim 2, wherein the pillar tube and the plurality of connection tubes are formed in such a manner that they are gradually narrower from upper end portion to lower end portion.

6. The electronic walking cane for the visually impaired for recognizing RFID tags according to claim 3, wherein the pillar tube and the plurality of connection tubes are formed in such a manner that they are gradually narrower from upper end portion to lower end portion.
